(19) United States
(12) Patent Application Publication
(10) Pub. No.: US 2008/0120510 A1
(43) Pub. Date: May 22, 2008

(54) System and method for permitting end user to decide what algorithm should be used to archive secure applications

(76) Inventors: David Carroll Challener, Raleigh, NC (US); John Hancock Nicholson, Durham, NC (US); Joseph Michael Pennisi, Apex, NC (US); Rod David Waltermann, Rougemont, NC (US)

Correspondence Address: ROGITZ & ASSOCIATES, 750 B STREET, SUITE 3120, SAN DIEGO, CA, 92101, US

(21) Appl. No.: 11/601,974

(22) Filed: Nov. 20, 2006

(51) Int. Cl. H04L 9/32

(52) U.S. Cl. 713/186

(57) ABSTRACT

An end user or IT owner via the use of an application specifies which TPM is to be loaded or which TPM operation is to be invoked given the authenticated presentation of a biometric such as a fingerprint or a token such as a smart card. A secure table stored in the microcontroller made up of TPM hashes and their corresponding endorsement keys is indexed to these authentication records. The microcontroller compares a received biometric or smart card value to the stored values to determine which TPM emulator to load. This architecture uniquely stores individually secured algorithms, and applications that can be bound to the user and the system on which they are running.

### I. FIELD OF THE INVENTION

The present invention relates generally to archiving secure applications.

### II. BACKGROUND OF THE INVENTION

Trust has become an important issue for e-commerce and other applications, particularly for mobile computing devices such as notebook computers. Specifically, as the mobility of the computing platform increases, it becomes susceptible to theft, with stolen data often representing a bigger loss than the hardware itself, because the data can include, e.g., user identity information, credit card information, and so on.

With this in mind, the Trusted Computing Group (TCG) has been formed to develop a specification for a trusted computing platform. A firmware application known as a Trusted Platform Module (TPM) can be loaded onto a hardware security module (actually, a microcontroller) that is soldered to the motherboard of the computing platform to establish what can be thought of as a platform root of trust that uniquely identifies a particular platform and that provides various cryptographic capabilities including hardware-protected storage, digital certificates, IKE (Internet Key Exchange), PKI (Public Key Infrastructure), and so on. Essentially, to overcome the vulnerability of storing encryption keys, authentication certificates, and the like on a hard disk drive, which might be removed or otherwise accessed or tampered with by unauthorized people, encryption keys, certificates, and other sensitive data is stored on the secure TPM.

Additionally, as understood herein a user might desire to maintain certain applications secure, even though the applications might be stored on a hard disk drive. For example, as e-commerce, e-government and e-business grows with increasing threat of cybercrime there is a tradeoff emerging in the use of security technologies for protecting data and authenticating identities and transactions. Information technology (IT) owners of processes involving these identities and transactions desire to use specific encryption algorithms tailored to their risk profiles. Associated with these algorithms, many users desire to use specific, feature set implementations of TPMs to support the required assurance level of end-to-end systems and operational models.

As further understood herein, the typical approach of implementing various algorithms and TPMs as delivered in unique or integrated hardware devices unfortunately entails relatively high security costs. As an example, more than a single chip (e.g., a co-processor for matching fingerprint authentication data, in addition to the chip hosting the TPM) is required in existing designs. Accordingly, as recognized herein it would be desirable to provide a flexible yet secure approach to use a secure programmable microcontroller to support various selectable encryption algorithms and incorporate these into the emulation of different instances of TPM hardware. To have this flexibility for being able to select multiple TPM emulators, end users and IT owners need a method to ensure they have physical control over the installation and a specific operation of the TPM.

### SUMMARY OF THE INVENTION

A computer system includes a hard disk drive (HDD), a computer processor, and random access memory. The system also includes a chip executing trusted platform modules (TPM) and communicating at least with the HDD. Also, a chip memory store is accessible only by the chip and no other components, and a bufferless keyboard provides input to the chip. A fingerprint reader and/or smart card reader provides user identification information to the chip, which can execute Java Card/Open Platform (JCOP).

As set forth further below, to initially install an application bound to a TPM, the chip intercepts a request to install the application and if the bound TPM currently is executing in the chip, the chip encrypts the application and stores it on the HDD. On the other hand, if the bound TPM is not currently executing in the chip, the chip requires proper user identification input by one or more of the keyboard, fingerprint reader, smart card reader prior to loading the first TPM. If proper identification is received, a signature of the first TPM is validated prior to allowing the TPM to store the application on the HDD.

To subsequently load an installed bound application, the chip intercepts the load request and if the bound TPM currently is executing in the chip, the chip decrypts the application and loads it into memory. If the bound TPM is not currently executing in the chip, the chip requires proper user identification input by one or more of the keyboard, fingerprint reader, smart card reader prior to loading the first TPM. If proper identification is received, the signature of the bound TPM is validated prior to allowing the TPM to load the application into memory.

In another aspect, a computer system includes a chip hosting a trusted platform module (TPM). The chip executes logic that includes intercepting a request to install an application bound to a first TPM, and if the first TPM currently is executing in the chip, encrypting the application and storing the application. If the first TPM is not currently executing in the chip, the logic includes requiring proper user identification input by one or more of a keyboard, fingerprint reader, smart card reader prior to loading the first TPM. In this aspect, if proper identification is received, the chip may validate a signature of the first TPM prior to allowing the TPM to store the application.

In yet another aspect, a computer system includes a chip hosting a trusted platform module (TPM) and executing logic that includes intercepting a request to load an installed application bound to a first TPM, and if the first TPM currently is executing in the chip, decrypting the application and loading it into memory. On the other hand, if the first TPM is not currently executing in the chip, the logic requires proper user identification input by one or more of a keyboard, fingerprint reader, smart card reader prior to loading the first TPM.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting computer that can use the present invention;

FIG. 2 is flow chart of a non-limiting implementation of the present application install logic; and

FIG. 3 is flow chart of a non-limiting implementation of the present application load logic.

### DETAILED DESCRIPTION OF THE PREFERRED EMBODIMENT

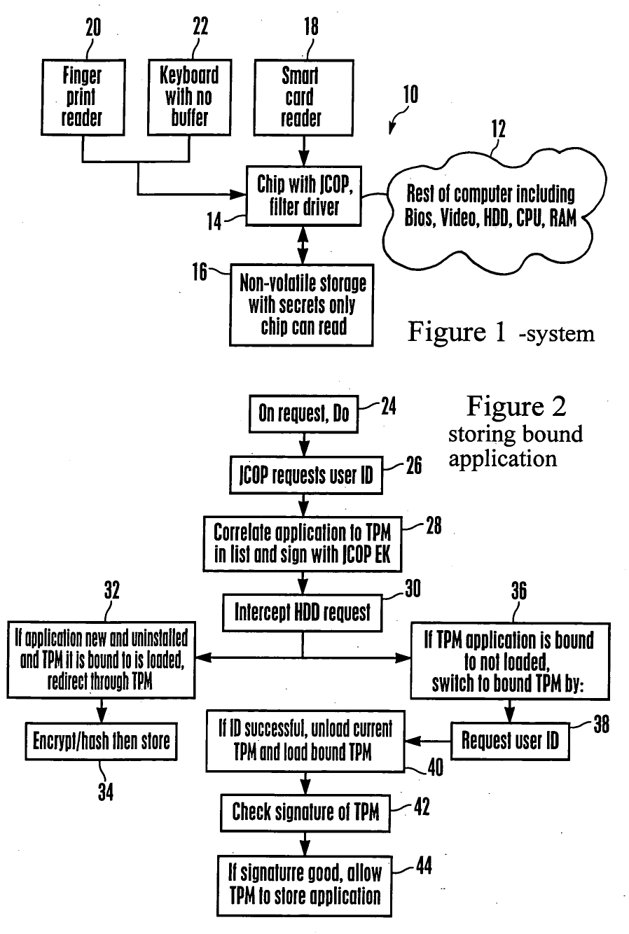

Referring initially to FIG. 1, a high-level block diagram of a data processing system, generally designated 10, is shown in which the present invention may be implemented. The system 10 in one non-limiting embodiment is a personal computer or laptop computer. The system 10 includes conventional components 12 including a processor that may be, without limitation, a PowerPC processor available from International Business Machines Corporation of Armonk, N.Y. (or other processors made by, e.g., Intel or AMD and common to the industry). Associated with the processor may be, without limitation, a basic input-output operating system (BIOS), a video monitor, a hard disk drive (HDD), and random access memory (RAM).

The system 10 may also include a chip 14 that can host one or more firmware- or software-implemented trusted platform modules (TPM). When a TPM is hosted on the chip 14, it can provide security functions in accordance with TPM principles known in the art, including the encryption, using a security key, data to be stored in the system 10.

In any case, the chip 14 embodies a microcontroller that in one non-limiting embodiment executes, as an operating system, the Java Card/Open Platform (JCOP). In accordance with principles discussed in greater detail below, the JCOP preferably has at least one endorsement key (EK) and a signed listing of authorized TPMs, along with associated bound applications, i.e., applications that are bound to particular TPMs. Additionally, the JCOP executes a filter driver for intercepting data read and write requests as discussed further below. Secrets including the EK may be stored on a non-volatile memory 16 that can be accessed only by the chip 14 and by no other components.

In one implementation, the above data can be stored in the non-volatile memory 16 as a secure table made up of TPM hashes correlated to corresponding endorsement keys and indexed to the authentication records, i.e., to approved user identification information discussed below (fingerprint and/or smart card ID and/or password) for each bound application.

In the system 10 shown in FIG. 1, the chip 14 can receive input from a smart card reader 18 that can be implemented by any appropriate device for reading so-called “smart cards” and the like that can be used as user identification tokens. Also, the chip 14 can receive input from a fingerprint reader 20 that can be implemented by any suitable device that generates digital signals representative of fingerprints when, e.g., a person places a finger against a platen of the reader. Further, a preferably bufferless keyboard 22 can be used to provide input in the form of, e.g., passwords to the chip 14. By “bufferless” is meant that the keyboard 22, unlike many typical keyboards, does not have a data buffer within its housing that otherwise might be used to house a malicious program for stealing keystrokes made when logging in.

Now referring to FIG. 2, at block 24 a request is sent to the JCOP (in response to, e.g., signals from the keyboard 22) to install aTPM/application binding. This triggers the JCOP to move to block 26 to request that the user identify themselves via, e.g., engaging an authorized token with the smartcard reader 18, or by placing a finger on the fingerprint reader 20, or by typing in an authorized password on the keyboard 22, or a combination thereof. Assuming proper identification, the process moves to block 28 to register the requested application-TPM binding by placing it in a list of authorized bindings and then for security resigning the list using the JCOP's EK. It should be understood that the failure of a user to properly identify himself ends the logic without registration of the requested binding.

Subsequently, when a request to write the now-bound application is sent to the HDD, the request is intercepted by the filter driver in the JCOP at block 30 and compared to the bound applications list. If the application is newly registered and not yet installed and if the TPM to which the application is bound matches the TPM that is currently loaded in the chip 14, the logic moves to block 32 to redirect the write through the TPM for encryption/hashing at block 34 before it the application is stored.

In contrast, if the TPM that is bound to the application is not loaded, the logic proceeds from block 30 to block 36 in which a request to switch TPMs is made to the JCOP. At block 38 the user is asked to identify himself using one of the methods discussed above. If identification is successful, the logic moves to block 40 to unload the current TPM from the chip and load in to the chip 14 the TPM that is identified in the list of registered bindings as being the TPM associated with the requested application. The requested TPM is decrypted prior to loading, and the decryption can be undertaken using several methods, including but not limited to the hash of the data used to authenticate the user, or the EK, etc.

Proceeding to block 42, once the TPM is installed in the JCOP on the chip 14, its signature is checked against the public key that is generated from the EK of the JCOP. That is, the TPM's private key can be generated from the JCOP's EK and checked. The TPM is not allowed to execute if the signature does not match, but otherwise is allowed to execute at block 44 to, e.g., store the associated bound application on the system 10 HDD, or on a network shared storage, or other storage. It is to be understood that in the some cases the JCOP's TPM emulation might be designated as single use only, in which case an error is generated.

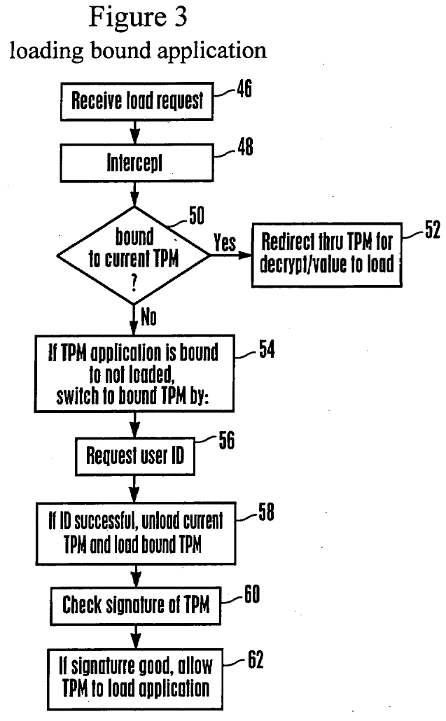

Now referring to FIG. 3 to understand how an application installed on the HDD in FIG. 2 can be loaded for use, at block 46 an application load request is sent to the HDD and at block 48 is intercepted by the filter driver. At decision diamond 50 the identity of the requested application is compared to the bound applications list to find the TPM to which it is bound, and if the corresponding TPM in the list matches the currently loaded TPM, the data read from the HDD is redirected through the TPM for decryption/validation at block 52 before it is loaded into memory. In contrast, if the TPM that is bound to the application is not currently loaded, a request to switch TPMs is made at block 54 to the JCOP. Assuming that the JCOP's TPM emulation is not marked as single use the following steps are performed. At block 56, the user is asked to identify himself using one of the methods discussed above. If identification is successful, the logic moves to block 58 to unload the current TPM from the chip and load in to the chip 14 the TPM that is identified in the list of registered bindings as being the TPM associated with the requested application. The requested TPM is decrypted prior to loading, and the decryption can be undertaken using several methods, including but not limited to the hash of the data used to authenticate the user, or the EK, etc.

Proceeding to block 60, once the TPM is installed in the JCOP on the chip 14, its signature is checked against the public key that is generated from the EK of the JCOP. The TPM is not allowed to execute if the signature does not match, but otherwise is allowed to execute at block 62 to, e.g., load the associated bound application into the memory of the system 10.

While the particular SYSTEM AND METHOD FOR PERMITTING END USER TO DECIDE WHAT ALGORITHM SHOULD BE USED TO ARCHIVE SECURE APPLICATIONS is herein shown and described in detail, it is to be understood that the subject matter which is encompassed by the present invention is limited only by the claims.

What is claimed is:

1. A computer system, comprising:
a hard disk drive (HDD), a computer processor, and random access memory;
a chip executing at least one trusted platform module (TPM) and communicating at least with the HDD;
a chip memory store accessible only by the chip and no other components;
a bufferless keyboard providing input to the chip; and
at least one of a fingerprint reader, smart card reader providing user identification information to the chip.

2. The system of claim 1, wherein the chip executes Java Card/Open Platform (JCOP).

3. The system of claim 1, wherein the chip intercepts a request to install an application bound to a first TPM, and if the first TPM currently is executing in the chip, the chip encrypts the application and stores it on the HDD.

4. The system of claim 3, wherein if the first TPM is not currently executing in the chip, the chip requires proper user identification input by one or more of the keyboard, fingerprint reader, smart card reader prior to loading the first TPM.

5. The system of claim 4, wherein if proper identification is received, a signature of the first TPM is validated prior to allowing the TPM to store the application on the HDD.

6. The system of claim 1, wherein the chip intercepts a request to load an application stored on the HDD and bound to a first TPM, and if the first TPM currently is executing in the chip, the chip decrypts the application and loads it into memory.

7. The system of claim 6, wherein if the first TPM is not currently executing in the chip, the chip requires proper user identification input by one or more of the keyboard, fingerprint reader, smart card reader prior to loading the first TPM.

8. The system of claim 7, wherein if proper identification is received, a signature of the first TPM is validated prior to allowing the TPM to load the application into memory.

9. A computer system, comprising:
at least one chip hosting a trusted platform module (TPM), the chip executing logic comprising:
intercepting a request to install an application bound to a first TPM;
if the first TPM currently is executing in the chip, encrypting the application and storing the application; and
if the first TPM is not currently executing in the chip, requiring proper user identification input by one or more of a keyboard, fingerprint reader, smart card reader prior to loading the first TPM.

10. The system of claim 9, wherein if proper identification is received, the chip validates a signature of the first TPM prior to allowing the TPM to store the application.

11. The system of claim 9, wherein the chip executes Java Card/Open Platform (JCOP).

12. The system of claim 9, wherein after storing an application bound to the first TPM, the chip intercepts a request to load the application, and if the first TPM currently is executing in the chip, the chip decrypts the application and loads it into memory.

13. The system of claim 12, wherein if the first TPM is not currently executing in the chip, the chip requires proper user identification input by one or more of a keyboard, fingerprint reader, smart card reader prior to loading the first TPM.

14. The system of claim 13, wherein if proper identification is received, a signature of the first TPM is validated prior to allowing the TPM to load the application into memory.

15. A computer system, comprising:
at least one chip hosting a trusted platform module (TPM), the chip executing logic comprising:
intercepting a request to load an installed application bound to a first TPM;
if the first TPM currently is executing in the chip, decrypting the application and loading it into memory; and
if the first TPM is not currently executing in the chip, requiring proper user identification input by one or more of a keyboard, fingerprint reader, smart card reader prior to loading the first TPM.

16. The system of claim 15, wherein if proper identification is received, a signature of the first TPM is validated prior to allowing the TPM to load the application into memory.

17. The system of claim 15, wherein the logic comprises:
intercepting a request to install an application bound to a first TPM;
if the first TPM currently is executing in the chip, encrypting the application and storing the application;
if the first TPM is not currently executing in the chip, requiring proper user identification input by one or more of a keyboard, fingerprint reader, smart card reader prior to loading the first TPM.

18. The system of claim 15, wherein if proper identification is received, the chip validates a signature of the first TPM prior to allowing the TPM to store the application.

19. The system of claim 15, wherein the chip executes Java Card/Open Platform (JCOP).
